(19) United States
(12) Patent Application Publication
(10) Pub. No.: US 2003/0123437 A1
(43) Pub. Date: Jul. 3, 2003

(54) Providing data via a communication network to a mobile subscriber

(76) Inventor: Mikko Nevalainen, Tampere (FI)

Correspondence Address: PERMAN & GREEN, 425 POST ROAD, FAIRFIELD, CT, 06824, US

(21) Appl. No.: 10/036,035

(22) Filed: Dec. 28, 2001

(51) Int. Cl. H04L 12/66

(52) U.S. Cl. 370/356

(57) ABSTRACT

The invention relates to a method for providing a mobile subscriber with data via a communication network, to which mobile subscriber a directory number is assigned and which communication network is capable of transmitting data addressed to said directory number. In order to improve the possibilities of re-directing service data, it is proposed that upon a request by the mobile subscriber to the communication network, data for at least one kind of telecommunication service addressed to the directory number is re-directed by the communication network to an internet address defined by said mobile subscriber. The invention equally relates to a corresponding mobile terminal, to a corresponding communication network and to a communication system comprising such a mobile terminal and such a communication network.

### FIELD OF THE INVENTION

The invention relates to a method for providing a mobile subscriber via a communication network with data, to which mobile subscriber a directory number is assigned and which communication network is capable of transmitting data addressed to said directory number. The invention equally relates to such a mobile terminal, to such a communication network and to a communication system.

### BACKGROUND OF THE INVENTION

It is known from the state of the art to use communication networks to provide various telecommunication services to a mobile subscriber via a mobile terminal, e.g. telephony or facsimile services. Further, multimedia messaging services MMS, enabled e.g. in Nokia 7650 mobile phone, are emerging as a messaging solution. For each of these services, data is addressed to the mobile subscriber's directory number and transmitted by the communication network accordingly. Since a directory number is assigned to a mobile subscriber via his/her SIM, the directory number is associated to a mobile terminal by inserting the SIM to this mobile terminal, and the data will be received by this mobile terminal.

It is moreover known from the state of the art to enable the provision of supplementary services in communication systems. According to the technical specification 3GPP TS 22.004 V4.0.0 (2001-03): “Technical Specification Group Services and System Aspects; General on supplementary services (Release 4)”, a supplementary service modifies or supplements a basic telecommunication service.

Examples of basic telecommunication services are listed for instance in the technical specification 3GPP TS 22.030 V4.0.0 (2001-03): “Technical Specification Group Services and System Aspects; Man-Machine Interface (MMI) of the User Equipment (UE) (Release 4)”. Included in the list are all tele and bearer services, all teleservices, telephony, all data teleservices, facsimile services, Short Message Services, all teleservices except SMS, voice group services including Voice Group Call Service (VGCS) and Voice Broadcast Service (VBS), all bearer services, all async services, all sync services, all data circuit sync, all data circuit async and all GPRS bearer services. To most of these services, a service code is assigned.

The basic telecommunication services are further grouped into different basic service groups. The basic service groups, to which the basic telecommunication services listed in TS 22.030 are assigned, are defined in the cited specification TS 22.004 to be speech, short message service, facsimile services, all data circuit asynchronous, all data circuit synchronous, voice group services and all GPRS (general packet radio system) access. The first basic service group speech, for example, comprises according to the specification TS 22.004 telephony and emergency call basic services.

To each basic service group, a basic service group number is assigned for identification. All basic telecommunication services within one basic service group can be addressed with this basic service group number. Thus, the basic service groups are defined to avoid the necessity of handling many basic service codes in case a supplementary service is to be associated to all basic telecommunication services of one or more basic service groups.

A supplementary service for a basic telecommunication service or for a basic service group can be provided individually for each user. The cited specification TS 22.004 further requests that any provided supplementary service can be registered, activated, deactivated, erased and interrogated.

The cited specification TS 22.030 further defines procedures for the registration, erasure, activation, deactivation and interrogation of supplementary services that have to be supported by the involved mobile terminal on the man-machine-interface MMI. The specification TS 22.030 also supports not-implemented supplementary services by allowing unstructured supplementary service data (USSD).

According to the technical specification 3GPP TS 22.090 V4.0.0 (2001-03). “Technical Specification Group Services and System Aspects; Unstructured Supplementary Service Data (USSD)—Stage 1 (Release 4)”, an MMI-mode USSD is provided for the transparent transport of MMI strings entered by the user to the network and for the transparent transport of text strings from the network that are displayed by the mobile station for user information. At any stage while the mobile terminal is registered with the network, the network may send an unstructured string to the mobile terminal. This string contains operator determined information that is relevant to the user. A network initiated USSD operation is supposed to contain an alphabet indicator and language indicator. The alphabet indicator is included for indicating the alphabet used in the operation. The network may explicitly indicate to the mobile terminal that a response from the user is required. In this case, the next string entered by the user is considered as the requested response and is therefore not interpreted according to the normal MMI procedures specified in the above cited specification TS 22.030.

The technical specification TS 22.004 lists several supplementary services, e.g. several call forwarding services. The details of call forwarding services are defined in the technical specification 3G TS 22.082 V3.0.1 6(1999-10). “Technical Specification Group Services and System Aspects; Call Forwarding (CF) supplementary services—Stage 1 (3G TS 22.082 version 3.0.1)”. An example for such call forwarding services for calls is the supplementary service “call forwarding unconditional”. This service permits a called mobile subscriber to have the network send all incoming calls addressed to the called mobile subscriber's directory number, or just those calls associated with a specific basic service group, to some other directory number.

In some cases, however, it might not be sufficient for a mobile subscriber to be able to re-direct data to another directory number. A mobile subscriber might for example want to make use of a service, like a multimedia messaging service, but is not able at the time when the service is provided to access a terminal that can on the one hand be reached via a directory number and that is on the other hand capable of handling the desired service.

Patent application EP 1 091 601 A2 deals with a situation, in which an employed mobile terminal is not capable of handling a content message provided by a multimedia messaging service center. It is proposed in this document that the messaging service center is capable of realizing that a mobile terminal is not capable of handling a specific content message, either because a message was not made use of during a preceding provision, or because of an indication by the mobile terminal that it is not capable of handling the content message. In both cases, the multimedia messaging service center posts the content message on a web page, in order to enable the user of the mobile terminal to view the message via a personal computer.

This approach has the disadvantage that a mobile subscriber is not able to control the re-direction of a service freely.

### SUMMARY OF THE INVENTION

It is an object of the invention to provide an improved possibility of forwarding service data which is addressed to a mobile subscriber's directory number It is in particular an object of the invention to enable a mobile subscriber to decide about a suitable forwarding of data for a specific service, e.g. for a multimedia messaging service, addressed to his/her directory number, for example because the terminal the subscriber currently uses is not capable of handling this service.

This object is reached with a method for providing a mobile subscriber with data via a communication network, to which mobile subscriber a directory number is assigned and which communication network is capable of transmitting data addressed to this directory number. It is proposed that upon a request by the mobile subscriber, data for at least one kind of service addressed to the directory number is re-directed by the communication network to a user defined internet address.

The object of the invention is equally reached with a mobile terminal comprising means for enabling a mobile subscriber to request such a re-direction and with a communication network comprising means for re-directing data upon a request by a mobile subscriber. Finally, the object of the invention is reached with a communication system comprising the proposed communication network and the proposed mobile terminal.

The invention proceeds from the idea that data does not necessarily have to be re-directed to another directory number, but could be re-directed alternatively to an internet address upon a request by a mobile subscriber. Such an internet address can be in particular an email address or the address of a web site.

It is an advantage of the invention that a mobile subscriber can make use of data also in case the data is directed to a mobile terminal which is not capable of handling this particular data properly due to missing features. Further, it is an advantage of the invention that a message exchange or “handshake” between a transmitting station and the addressed mobile terminal preceding the transmission of service data is not required in order to enable the transmitting end to know whether the data of some service, for instance a multimedia messaging service, can be handled by the addressed mobile terminal or not. Such a “handshaking” for multimedia messaging services, by which the mobile terminal communicates its capabilities to the network, is described for example in the patent application WO 01/58198. Also, a service provider does not have to be aware of the facilities of the mobile terminal to which it directs data for a specific service. Neither does the originator need to know what kind of a terminal the mobile subscriber to whom the directory number is assigned is using.

Preferred embodiments of the invention become apparent from the dependent claims.

The data that is to be re-directed to an internet address can belong to any service that may be provided via a mobile communication network, in particular to multimedia messaging services as well as to audio, video, and streaming video and audio services. In the case of MMS, it is the entire message belonging to a service that is re-directed.

The necessary features for realizing the invention can be implemented in a network: element of the network. These features preferably include a conversion of the data into a format that can be handled in an internet environment and the actual re-direction of the converted data to an internet address. In order to enable a mobile subscriber to request a re-direction to a desired internet address via a mobile terminal, such a mobile terminal preferably comprises an application enabling such a request. Alternatively, the re-direction can be controlled by the user of a mobile terminal via man-machine-interface strings or by a SIM application toolkit.

Preferably, though not necessarily, at least one basic service group is defined in the communication network, for which basic service group the re-direction to an internet address can be requested. Once a re-direction for a basic service group to a specific internet address is requested by a mobile subscriber, all data which is directed to the mobile terminal and belong to a service of this service group can be re-directed automatically to the defined internet address. A basic service group can be defined for any new media or for a combination of media for separate handling, e.g. for multimedia messaging services, for video, and for streaming video and audio. The at least one basic service group can be defined in the network in particular in addition to the basic service groups currently defined in the above cited specification TS 22.004.

The proposed method may-thus be realized as an additional supplementary service as defined in the above cited specification TS 22.004.

The method according to the invention can be realized in particular analogously to the current unconditional call forwarding as defined in the above cited specification TS 22.082, including registration, erasure, activation, deactivation and interrogation. However, the special requirements of the invention have to be taken into account. The internet-address, for example, cannot be transmitted like a directory number in the specified unconditional call forwarding, since only some of the alphabets and only certain codes, are allowed to be transmitted. In particular, the transmission of characters, which are required for an internet address, cannot be transmitted in the specified call forwarding. Moreover, the length of the string that can be transmitted in the specified call forwarding is limited as well. Thus, the transmission of the internet address has to be performed in some other way, e.g. via USSD.

A registration can be employed for providing the internet address, and possibly in addition an indication of the basic service group or groups for which the re-direction to this internet address is to be carried out, to the communication network. Providing an indication of at least one basic group number may also be obligatory, as in the unconditional call forwarding for voice specified in the specification TS 22.082. The communication network will then store the received information for the directory number that is currently associated to the mobile terminal employed for the registration. A successful registration may include the activation of the service, as specified for a successful unconditional call forwarding in the specification TS 22.082. Alternatively, the activation has to be carried out separately also for the first activation after a registration.

According to the current MMS specifications, when a MMS is to be provided, a notification message is sent to the recipient by means of a short message service (SMS). The recipient can then retrieve the message from a multimedia messaging service center MM-SC providing the multimedia messaging service. It has also been proposed, however, to deliver the MM-SC messages to the recipient without any notification messages, using WAP (Wireless Application Protocol) PUSH. The invention can be advantageously employed, for example, in case a service that can be handled by a WAP terminal is desired by a user of a mobile terminal not supporting WAP.

Other objects and features of the present invention will become apparent from the following detailed description considered in conjunction with the accompanying drawing. It is to be understood, however, that the drawing are designed solely for purposes of illustration and not as a definition of the limits of the invention, for which reference should be made to the appended claims. It should be further understood that the drawing is not drawn to scale and that it is merely intended to conceptually illustrate the structures and procedures described herein.

### BRIEF DESCRIPTION OF THE FIGURES

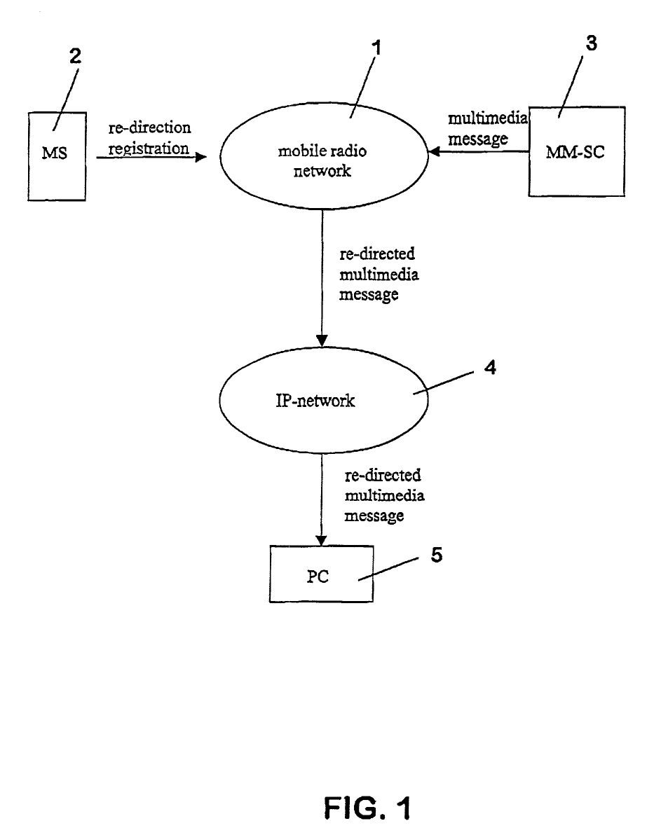

In the following, the invention is explained in more detail with reference to FIG. 1, which schematically shows a communications system in which an embodiment of the method according to the invention can be employed.

### DETAILED DESCRIPTION OF THE INVENTION

FIG. 1 schematically shows a communication system, in which messages addressed to a directory number can be redirected to an email address.

The communication system comprises a mobile communication network 1, which is composed of a core network and several radio access networks connected to the core network. The structure of the mobile communication network 1 is not depicted in detail in FIG. 1. A mobile station 2 is able to access the mobile communication network 1 via one of the radio access networks. The mobile communication network 1 is further connected to a multimedia messaging service center MM-SC 3 and via an IP-network 4 to a user PC 5. The user of the mobile station 2 has activated a multimedia messaging service provided by the multimedia messaging server 3.

The depicted communication system operates in a known manner and comprises to this end the known elements and functions. The mobile communication network 1 and the mobile station 2, however, have been adapted according to the invention for enabling a re-direction of multimedia messages provided by a multimedia messaging service provider via the MM-SC 3 to an email address.

A network element of the mobile communication network 1 stores a list of basic service groups, to each of which basic service groups basic telecommunication services are associated. These basic telecommunication services can be modified or supplemented by provided supplementary services. The list of basic service groups corresponds to the list specified in the above cited specification TS 22.004. But in the depicted mobile communication network 1, an additional basic service group was added to this known list, a basic service group for multimedia messaging services.

In order to enable a re-direction of multimedia messages addressed to a specific directory number, e.g. the directory number associated to the SIM in the mobile terminal 2, a network element of the mobile communication network 1 further comprises a function which allows to apply the unconditional forwarding defined in the above cited specification TS 22.082 also to the new basic service group for multimedia messaging services. For this new group, an additional possibility of re-directing a message is provided, namely re-directing multimedia messages to an email address. To this end, the mentioned network element of the mobile communication network 1 further comprises a function for converting a received multimedia messages into a format readable in a standard email environment. In addition, the network element comprises a function for changing the directory number to which the multimedia message is directed to an email address defined by a mobile subscriber.

Since a mobile subscriber might use his/her SIM card on the one hand in a mobile station capable of handling multimedia messages and on the other hand in a mobile station 2 not capable of handling multimedia messages, the supplementary service of re-directing multimedia messages to an email address instead of to a directory number can be switched on and off by the user of the mobile station 2.

There may also be a variety of other reasons for which a mobile subscriber might wish to receive multimedia messages on some occasions on a mobile phone and on other occasions via an email address. During vacation, for instance, a mobile subscriber might prefer to make use of the provided multimedia service later on from an email account. Further, a terminal capable of handling any kind of multimedia messaging services, video or other data might still have a limited memory capacity. The mobile subscriber might thus prefer sometimes to read messages from an email account. Moreover, the data for an expected video might be rather extensive, and the mobile subscriber does not want to download too much data due to resulting high expenses. In addition to saving costs, a re-direction to an email address may also save battery and downloading time at the mobile terminal. On the other hand, a mobile subscriber might want to save costs and/or time and thus to re-direct messages to an email address only at some times, while at other times he/she would prefer not to re-direct messages but to receive them immediately.

There may equally be other personal preferences. A mobile subscriber might for example want to distinguish between nighttime and daytime, between being in the office and out of office, or between being in his/her home country and abroad. The mobile subscriber might also want to distinguish between walking and driving, since when driving, there might be a car kit available with an extra antenna and the possibility of charging the battery of the mobile terminal.

In addition to personal preferences, switching a re-direction on or off might depend on the available office equipment, on personal accessories at home, on the current location, etc.

To this end, five different communications between the mobile station 2 and the mobile communication network 1 are defined for enabling a registration, an erasure, an activation, a deactivation and an interrogation of the new supplementary service of re-directing a multimedia message to an email address. The definitions correspond basically to those relating to the unconditional call forwarding in the above cited specification TS 22.082.

The first communication is aimed at registering possible re-directions of multimedia messages for the directory number assigned to the SIM of the mobile station 2. In this communication, a user of the mobile station 2 registers an unconditional forwarding of all multimedia messages addressed to this directory number to his/her email address by providing this email address to the mobile communication network 1.

More specifically, the user first requests the service either via the mobile station user interface (UI) or via the man-machine-interface (MMI). The request comprises information about the forwarding procedure that is to be registered, i.e. that the forwarding is to be unconditional. Moreover, the request comprises an identification of the basic service groups that are to be involved, i.e. an identification of the basic service group for multimedia messaging services. The email address is not yet provided in this request, since this is not an option in the defined request. Instead, the email address of the user is requested in a subsequent step as network initiated USSD message. The use of USSD messages as such is defined in the above cited specification TS 22.090. The messaging part of the USSD message could be for instance “Please provide email address for MMS forwarding”. The user is informed by the mobile station 2 about the received USSD message and enters the email address using the standard GSM alphabet. A reply message comprising this email address is then transmitted as USSD message to the network 1. The mobile communication network 1 stores the received information for the directory number assigned to the SIM in the mobile station 2. As a result, the re-direction of multimedia messages is registered and activated. An activated re-direction implies that any multimedia message directed to the directory number of the SIM of the mobile station 2 will not be attempted to be delivered to a mobile station, but will be immediately re-directed by the mobile communication network 1 to the indicated email address.

The second communication is aimed at activating a registered but inactive re-direction. Once the re-direction of multimedia messages is registered and the mobile communication network 1 is in possession of the email address to which the re-direction is to be carried out, the user of the mobile station 2 may activate an inactive re-direction of multimedia messages to the indicated email address by a corresponding request whenever required.

An activation request by a mobile station 2 will only result in an activation of the new forwarding service, if the mobile communication network 1 has knowledge of an email address to which multimedia messages are to be forwarded. In case the user tries to activate forwarding multimedia messages while no email address is not known at the mobile communication network 1, the request for an activation fails. The email address may be unknown either because the user did not register the supplementary service before, or because a provided email address has been erased again. The functions provided for this forwarding service for multimedia messages are thus similar as in the case of normal voice call forwarding services.

With a third defined communication, a user may deactivate an activated re-direction of multimedia messages again. To this end, the user sends a corresponding request to the network 1, again either via the UI or the MMI of the mobile station. As a reaction to this request, the mobile communication network 1 deactivates the re-direction, but keeps the email address. This enables the user to activate the service again in the future without the necessity of a new registration.

With a fourth defined communication, the user may also erase the registration for re-directing multimedia messages again. There are several reasons for which a user might desire to erase a registration. The user may have changed for example his/her mobile station, and the new mobile station is able to handle multimedia messaging services. Equally, the user may have momentarily some extra memory available on the mobile equipment which enables handling multimedia messaging services, and in the future he/she will have a new email address, which requires a new registration. Also for erasing the registration, the user sends a corresponding request to the network 1 via the UI or the MMI of the mobile station 2. All user data, i.e. the email address and the basic service group for which the re-direction to this email address was activated, is erased from the network element of the mobile communication network 1 storing this data. In case a forwarding was still active, the forwarding is no longer active after the registration has been erased.

A fifth defined communication enables the user to interrogate the current status of the forwarding service for multimedia messages at any time. The interrogation is performed in a similar manner as defined in the above cited specification TS 22.082 for unconditional call forwarding. However, the request is not mixed with an interrogation for the unconditional call forwarding for other basic service groups, since in contrast to the known call forwarding, which involves only a new phone number, in the new supplementary service an email address is involved.

For the interrogation, the user thus sends via the mobile station 2 the same request to the mobile communication network 1 as for the known interrogation for unconditional call forwarding, but defines the basic service group to be the basic service group for multimedia messaging services. An answer is sent to the mobile station 2 as network initiated USSD, since the current method for delivering information about a forwarding status includes only the identification of the basic service group and the phone number to which a forwarding is carried out.

A re-direction of a multimedia message according to the invention based on the above functions implemented in the mobile station 2 and the mobile communication network 1 will now be described with reference to FIG. 1.

A user has subscribed a multimedia messaging service provided by a multimedia messaging service provider. Currently, the user is however employing a mobile station 2 that is not capable of handling multimedia messaging services.

Therefore, the user registers a re-direction of all multimedia messages directed to his/her directory number as described above. During this registration, the user provides the network 1 with an email address to which he/she has access. The registration results at the same time in an activation of the re-direction. The registration is indicated in the figure by an arrow between the mobile station 2 and the mobile communication network 1.

The multimedia server 3 now provides messages for a multimedia messaging service to the mobile communication network 1, which is indicated in the figure as well by an arrow. The multimedia messages are directed to the directory number of the user. Since a re-direction of multimedia messages was registered and activated for this directory number, the mobile communication network 1 does not forward the multimedia messages to the indicated phone number. Instead, the mobile communication network 1 converts the multimedia messages to a format that can be handled in a normal email environment. Further, the mobile communication network 1 re-directs the converted multimedia messages to the email address indicated by the user during registration.

The converted multimedia messages are then provided to the IP network 4 connected to the mobile communication network 1, which is indicated in the figure as well by an arrow. The IP network 4 forwards the received multimedia messages like a normal email to the email-server indicated by the email address.

The user is then able to download the email via his/her user PC 5 from the email server, which download is indicated in the figure again by an arrow, and to make use of the multimedia messaging service provided with the received multimedia messages.

Later, the user may deactivate the re-direction, as described above, because he/she will now use for some time another mobile station which is capable of handling multimedia messages. As a result of the deactivation, all messages provided for multimedia messaging services are transmitted to the mobile station which now comprises the SIM of the user. When switching back to the previously used mobile station, the user only has to activate the re-direction again as described above, without the necessity of a new registration. Only in case the user decides to switch completely to a mobile station capable of handling multimedia messaging services, he/she will erase the registration of the re-direction as described above, since it is not needed any more.

Alternatively or additionally, the mobile subscriber can be enabled to re-direct multimedia messages to a web-site instead of to an email address. The handling of such a re-direction can be carried out as the above described handling of a re-direction to an email address. Web-addresses like FTP addresses can be extremely long and have a rather complex structure, e.g. “ftp://domain.com/my_files/uploaded”. Thus also in this case USSD can be used advantageously for transmitting a desired FTP address from the mobile subscriber to the network. The re-direction to the indicated FTP address can be carried out for example by using an FTP upload. In this case, the mobile subscriber is able to download the messages later on via a PC from the indicated web-site.

While there have shown and described and pointed out fundamental novel features of the invention as applied to a preferred embodiment thereof, it will be understood that various omissions and substitutions and changes in the form and details of the devices and methods described may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

what is claimed is:

1. A method for providing a mobile subscriber with data via a communication network, to which mobile subscriber a directory number is assigned, and which communication network is capable of transmitting data addressed to said directory number, wherein upon a request by said mobile subscriber to said communication network, data for at least one kind of telecommunication service addressed to said directory number is re-directed by said communication network to an internet address defined by said mobile subscriber.

2. A method according to claim 1, wherein said data is converted into a format that can be handled by an internet environment before it is re-directed to an internet address.

3. A method according to claim 1, wherein said data consists in one of multimedia messages, video data, audio data, and streaming audio and video data.

4. A method according to claim 1, wherein said request of a re-direction of data for at least one kind of service comprises a registration, for which registration said mobile subscriber provides said communication network with said internet address, which provided internet address is stored in said communication network for said directory number.

5. A method according to claim 4, wherein said registration of a re-direction can be erased again by a mobile subscriber.

6. A method according to claim 4, wherein said registration results at the same time in an activation of said registered re-direction.

7. A method according to claim 6, wherein an activated re-direction can be deactivated again by a mobile subscriber.

8. A method according to claim 1, wherein said request for a re-direction comprises an activation by said mobile subscriber of an inactive re-direction of said data to an internet address stored in said communication network for said directory number.

9. A method according to claim 8, wherein an activated re-direction can be deactivated again by a mobile subscriber.

10. A method according to claim 1, wherein upon an interrogation by said mobile subscriber, information stored in said communication network for said directory number for a re-direction to an internet address is transmitted by said communication network to said mobile terminal.

11. A method according to claim 1, wherein at least one basic service group is defined in said communication network, wherein at least one kind of basic telecommunication service is associated to said at least one basic service group, wherein a request for a re-direction by a mobile subscriber comprises an identification of at least one basic service group defined in said communication network, and wherein all data belonging to a basic telecommunication service associated to said at least one identified basic service group is re-directed to said internet address.

12. A method according to claim 1, wherein said internet address is an email address.

13. A method according to claim 1, wherein said internet address is an address of a web site.

14. A mobile terminal comprising means for enabling a mobile subscriber to request from a communication network to which said mobile terminal is connected to re-direct data for at least one kind of telecommunication service addressed to a specific directory number to an internet address defined by said mobile subscriber.

15. A communication network comprising means for re-directing upon a request by a mobile subscriber data for at least one kind of telecommunication service addressed to a specific directory number to an internet address defined by said mobile subscriber.

16. A communication network according to claim 15, further comprising means for converting said data into a format that can be handled by an internet environment before re-directing said data to said internet address.

17. A communication network according to claim 15, further comprising storing means for storing a list of basic service groups, to each of which basic service groups at least one kind of basic telecommunication service is associated, wherein data for all services associated to at least one of said basic service groups can be requested by a mobile subscriber to be re-directed to an internet address.

18. A communication system comprising a communication network with means for re-directing upon a request by a mobile subscriber data for at least one kind of telecommunication service addressed to a specific directory number to an internet address defined by said mobile subscriber, said communication system further comprising at least one mobile terminal with means for enabling a mobile subscriber to request from a communication network to which said mobile terminal is connected to re-direct data for at least one kind of telecommunication service addressed to a specific directory number to an internet address defined by said mobile subscriber.
